(19) United States
(12) Patent Application Publication
(10) Pub. No.: US 2026/0067516 A1
(43) Pub. Date: Mar. 5, 2026

(54) HOUSEHOLD DEMOGRAPHIC ASSIGNMENT USING TARGETS THAT ACCOUNT FOR PROVIDER OVERLAP

(71) Applicant: The Nielsen Company (US), LLC, New York, NY (US)

(72) Inventors: Denis Voytenko, Tampa, FL (US); Keith Tirimba, Tampa, FL (US); Paul Chimenti, Lakewood, NY (US); Michael Sheppard, Holland, MI (US); Joshua Deragon, Pittsburgh, PA (US); Horalia Armas, Palentine, IL (US)

(21) Appl. No.: 19/279,535

(22) Filed: Jul. 24, 2025

Related U.S. Application Data
(60) Provisional application No. 63/689,913, filed on Sep. 3, 2024.

(51) Int. Cl. H04N 21/258

(52) U.S. Cl. CPC H04N 21/25883

(57) ABSTRACT

An example method includes determining, for each of multiple digital media providers, respective estimated distributions of a characteristic for a television viewing area. The method also includes determining respective reach values based on a universe estimate for the television viewing area. In addition, the method includes determining a distribution of subscribers across overlapping combinations of the digital media providers. The method also includes determining, for each of the multiple digital media providers based on the distribution of subscribers, respective mixed provider fractions relative to a total provider fraction for the digital media provider. The method further includes determining, using a constrained optimization routine, target distributions of the characteristic for combinations of the digital media providers. And the method includes using the target distributions as a basis for assigning values of the characteristic to households that are subscribes of the digital media providers and located in the television viewing area.

### CROSS-REFERENCE TO RELATED APPLICATIONS

This disclosure claims the benefit of U.S. Provisional Application No. 63/689,913, filed on Sep. 3, 2024, the entire contents of which are hereby incorporated by reference.

### BACKGROUND

Audience measurement entities (AMEs), such as The Nielsen Company (US), LLC, may extrapolate ratings metrics and/or other audience measurement data for a total television viewing audience from a sample of panel homes. The panel homes may be chosen to be representative of an audience universe as a whole. Furthermore, to help supplement panel data, an AME may license television tuning information from third parties. The television tuning information may be derived from set-top boxes and/or other devices that deliver television content to households.

### SUMMARY

Existing household demographic assignment models seek to assign one or more demographic categories to return path data households. Some household demographic assignment models leverage mixed integer programming. With this approach, the most likely assignment of individuals to each household is solved for programmatically, subject to a number of logical constraints. Those logical constraints include provider-specific demographic distribution targets for individual television viewing areas (e.g., designated market areas). The systems and methods disclosed herein provide a methodology to solve for demographic distribution targets in a manner that accounts for potential overlaps between digital media providers in the television viewing areas. For instance, a television viewing area may be served by both a first digital media provider and a second digital media provider, with some households being subscribers to both digital media providers. The methodology described herein can be used to establish demographic distribution targets that are specific to an overlap in subscribership between the first digital media provider and the second digital media provider rather than separately establishing: first demographic distribution targets for the first digital media provider using just data from the first digital media provider; and second demographic distributions targets for the second digital media provider using just data from the second digital media provider.

In one aspect, a computing system is described. The computing system includes a processor and a memory, and is configured to perform a set of acts. The set of acts includes determining, for each of multiple digital media providers, respective estimated distributions of a characteristic for a television viewing area. The set of acts also includes determining, for each of the multiple digital media providers, respective reach values based on a universe estimate for the television viewing area. In addition, the set of acts includes determining, based on the respective reach values, a distribution of subscribers across overlapping combinations of the digital media providers. The set of acts further includes determining, for each of the multiple digital media providers based on the distribution of subscribers, respective mixed provider fractions relative to a total provider fraction for the digital media provider. The set of acts further includes determining, using a constrained optimization routine that is constrained by the mixed provider fractions and the estimated distributions of the characteristic, target distributions of the characteristic for combinations of the digital media providers. And the set of acts includes using the target distributions of the characteristic as a basis for assigning values of the characteristic to households that are subscribes of the digital media providers and located in the television viewing area.

In another aspect, a method is described. The method includes determining, by a computing system, for each of multiple digital media providers, respective estimated distributions of a characteristic for a television viewing area. The method also includes determining, by the computing system for each of the multiple digital media providers, respective reach values based on a universe estimate for the television viewing area. In addition, the method includes determining, by the computing system based on the respective reach values, a distribution of subscribers across overlapping combinations of the digital media providers. The method also includes determining, by the computing system for each of the multiple digital media providers based on the distribution of subscribers, respective mixed provider fractions relative to a total provider fraction for the digital media provider. The method further includes determining, by the computing system using a constrained optimization routine that is constrained by the mixed provider fractions and the estimated distributions of the characteristic, target distributions of the characteristic for combinations of the digital media providers. And the method includes using the target distributions of the characteristic as a basis for assigning values of the characteristic to households that are subscribes of the digital media providers and located in the television viewing area.

In another aspect, a non-transitory computer-readable storage medium is described. The non-transitory computer-readable storage medium has stored thereon instruction, that upon execution by a computing system, cause the computing system to perform a set of acts. The set of acts includes determining, for each of multiple digital media providers, respective estimated distributions of a characteristic for a television viewing area. The set of acts also includes determining, for each of the multiple digital media providers, respective reach values based on a universe estimate for the television viewing area. In addition, the set of acts includes determining, based on the respective reach values, a distribution of subscribers across overlapping combinations of the digital media providers. The set of acts further includes determining, for each of the multiple digital media providers based on the distribution of subscribers, respective mixed provider fractions relative to a total provider fraction for the digital media provider. The set of acts further includes determining, using a constrained optimization routine that is constrained by the mixed provider fractions and the estimated distributions of the characteristic, target distributions of the characteristic for combinations of the digital media providers. And the set of acts includes using the target distributions of the characteristic as a basis for assigning values of the characteristic to households that are subscribes of the digital media providers and located in the television viewing area.

### BRIEF DESCRIPTION OF THE DRAWINGS

FIG. 1 is a conceptual illustration of an example measurement process.

FIG. 2 is a simplified block diagram of an example audience measurement computing system in which various described operations can be implemented.

FIG. 3 illustrates example data for a television viewing area.

FIG. 4 illustrates additional example data for the television viewing area described with reference to FIG. 3.

FIG. 5 illustrates additional example data for the television viewing area described with reference to FIG. 3.

FIG. 6 conceptual illustrates an optimization problem and solution.

FIG. 7 is a flow chart of an example method.

FIG. 8 is a simplified block diagram of an example computing device.

### DETAILED DESCRIPTION

### 1. Overview

Existing household demographic assignment models seek to assign one or more demographic categories to return path data (RPD) households using probability data. By way of example, neural-network based demographic estimation systems use panel data collected from monitored panelist households as a training set for training a neural network. The trained neural network is then able to predict from RPD, probabilities of different household demographic characteristics being associated with respective ones of the RPD households reporting the RPD.

Demographic assignment models use the probabilities generated by a neural network based demographic estimation system, or other type of estimation system to binarize the probabilities output by the demographic estimation system and definitively assign demographic occupancy of each RPD household. Binarizing a probability can be viewed as converting the probability to either zero percent or one hundred percent.

A naive method for binarizing the demographic predictions might be to simply round the probabilities to a nearest integer value of zero or one. But this straightforward approach would introduce a number of significant sources of biases if it were used to assign all unknown homes. For instance, simple rounding ignores prior information about the geolocation of each household, as different geographic regions have different demographic compositions. Moreover, rounding merely considers the assignment of each household individually, rather than in a manner that seeks to match the global distribution of demographic attributes expected in a given geographic region.

To address these issues, some household demographic assignment models leverage mixed integer programming. With this approach, the most likely assignment of individuals to each household is solved for programmatically, subject to a number of logical constraints. Those logical constraints include demographic distribution targets for individual television viewing areas (e.g., designated market areas). One example of a demographic distribution target is that 10% of households in a television viewing area are Hispanic, and 90% of households in a television viewing area are non-Hispanic. Another example of a demographic distribution target is that 80% of households in the television viewing area that subscribe to a specific digital media provider are Hispanic, and 20% of households in the television viewing area that subscribe to the specific digital media provider are non-Hispanic.

When assigning individuals to households at the provider-level (e.g., assigning individuals to households for all households that are subscribers of a given RPD provider), it is useful to have accurate distribution targets that are specific to the provider. However, increasingly, households subscribe to multiple digital media providers such that relying on demographic distribution targets for distinct combinations of television viewing area and digital media provider is no longer an optimal solution. For instance, by relying on such single-provider combinations, a household demographic assignment model could erroneously and inaccurately predict a first set of demographics for a household when relying on RPD from a first digital media provider and predict a second, different set of demographics for the same household when relying on RPD from a second digital media provider.

The systems and methods disclosed herein provide a methodology for solving for demographic distribution targets in a manner that accounts for the overlaps between digital media providers in a television viewing area. As described herein, the methodology uses reach values for each of multiple providers in a television viewing area to determine a distribution of subscribers across overlapping combinations of the digital media providers. For instance, the reach values can be used with the assumption of independence and the inclusion-exclusion principle to determine the fraction attributed to each of multiple possible overlap combinations. Moreover, the possible fractions can then be rescaled to estimate the mixed provider fraction of each overlap combination. Moreover, the methodology leverages a constrained optimization routine to estimate target distributions of a characteristic for the combinations of the digital media providers in the television viewing area.

### II. System Architecture

### a. Example Measurement Process

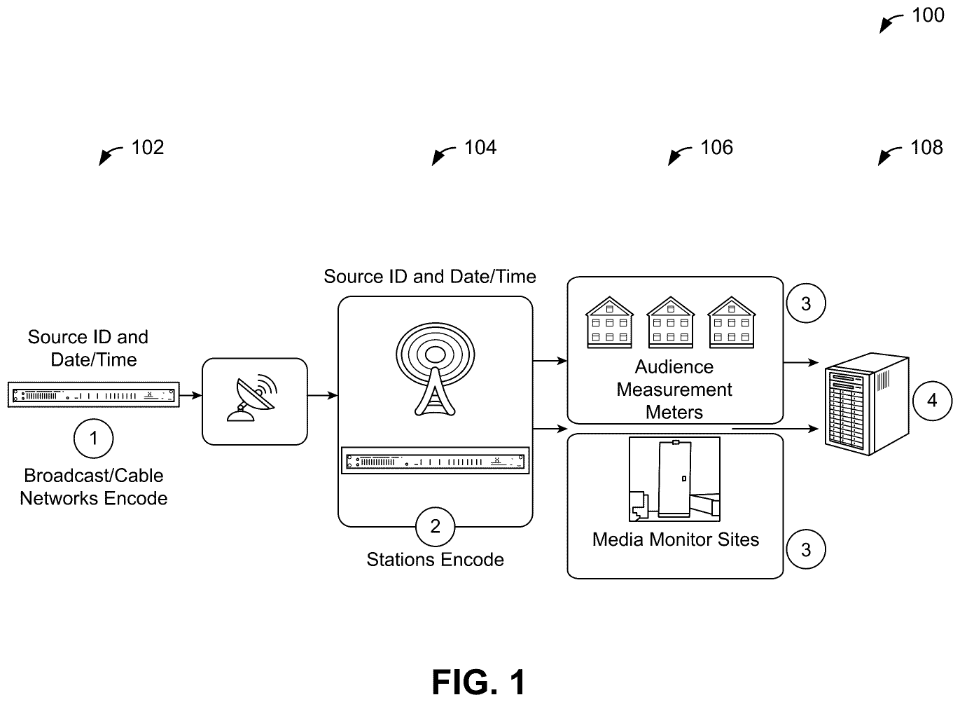

FIG. 1 is a conceptual illustration of an example measurement process 100. Measurement process 100 depicts operations that can be carried out within an audience measurement system. More specifically, FIG. 1 shows measurement process 100 as including a first stage 102, a second stage 104, a third stage 106, and a fourth stage 108.

As part of first stage 102, a broadcast/cable network encodes watermarks into media content using an encoder. A watermark is any identification information that may be inserted or embedded in the audio or video of media (e.g., a program or an advertisement) for the purpose of identifying the media. In other words, the watermark can include an audio watermark or a video watermark. In some examples, the watermark is imperceptible to humans. By way of example, during first stage 102, a television network can encode an audio watermark into media. The audio watermark can include a source identifier (e.g., a station identifier) as well as a date and/or time.

After the watermark is inserted, the broadcast/cable network distributes the watermarked media to a television station, such as a local television station for a geographic region. At second stage 104, the television station encodes watermarks into the media. For instance, the television station can encode watermarks into local media that is specific to the geographic region, such as advertisements or local programming. The television station then distributes the watermarked media to various households in the geographic region.

During third stage 106, an audience measurement meter in a panelist household monitors media content that is presented within the panelist household. For instance, the audience measurement meter detects the watermarks and decodes the watermarks so as to reveal the identification information (i.e., the source identifier and date and/or time).

The audience measurement meter then reports the identification information to a remote computing system of an AME. For instance, the audience measurement meter may be connected to a local network of the panelist household, such that the audience measurement meter can transmit the identification information to the remote computing system via the local network and the internet. Or the audience measurement meter can transmit the identification to the remote computing system using a cellular modem of the audience measurement meter.

In some examples, the AME provides the audience measurement meter to the panelist household such that the audience measurement meter may be installed in a media presentation environment of the panelist household. The audience measurement meter can be installed by a panelist by simply powering the audience measurement meter and placing the audience measurement meter near a presentation device (e.g., a television). Alternatively, a field representation of the AME may visit the panelist household to install and configure the audience measurement meter.

In some examples, to monitor media presented by the presentation device, the audience measurement meter senses audio (e.g., acoustic signals or ambient audio) output by the presentation device. For example, the audience measurement meter processes the signals obtained from the media presentation device to detect media and/or source identifying signals (e.g., audio watermarks) embedded in the media presented by the presentation device. In some examples, the audience measurement meter includes a microphone array to sense ambient audio. Additionally or alternatively, the audience measurement meter may directly receive audio signals from the presentation device via a wired or wireless connection with the presentation device.

In some examples, the audience measurement meter can sense video output by the presentation device, and utilize video watermarking to obtain identification information for the media presented by the presentation device.

Further, instead of or in addition to detecting watermarks, the audience measurement meter can utilize fingerprint-based media identification techniques. Unlike media monitoring techniques based on watermarks included with and/or embedded in the monitored media, fingerprint-based media monitoring techniques generally use one or more inherent characteristics of the monitored media during a monitoring time interval to generate a substantially unique proxy for the media. Such a proxy is referred to as fingerprint, and can take any form representative of any aspect of the media signal (e.g., the audio and/or video signals forming the media presentation being monitored).

Fingerprint-based media monitoring generally involves determining signatures representative of a media signal output by a monitored presentation device and comparing the monitored signatures to one or more reference signatures corresponding to known media sources. To facilitate this comparison, the audience measurement meter generates signatures, and transmits the signatures to the remote computing system of the AME. In addition, a plurality of media monitor sites receive media content distributed within a geographic region, generate reference signatures for the media content, and associate identification information with the reference signatures. The identification information can include any combination of a date/time, channel, or media identifier. Alternatively, the audience measurement meter can compare a generated signature against a reference database of signatures stored by the audience measurement meter. Various comparison criteria, such as a cross-correlation value or a Hamming distance, can be evaluated to determine whether a generated signature matches a particular reference signature. After matching the generated signature with a signature of the reference database, the audience measurement meter can report metadata associated with the matching signature (e.g., a media title, a presentation time, and/or a broadcast channel) to the remote computing system of the AME.

In some examples, to generate exposure data for the media, identification information for media to which the panelists in a panelist household are exposed is correlated with people data (e.g., presence information) collected by the audience measurement meter. By way of example, the audience measurement meter collects inputs (e.g., audience identification data) representative of the identities of the panelists. The audience measurement meter can collect audience identification data by periodically or a periodically prompting panelists in the media presentation environment to identify themselves as present in the audience. Panelists can indicate their presence by pressing an appropriate key on an input device, such as a remote control, a touchscreen, or an application running on a mobile device. Alternatively, the audience measurement meter can collect audience identification data by capturing images of the media presentation environment with a camera and analyzing the images via face recognition to identify which panelist(s) are present in the media presentation environment. Likewise, the audience measurement meter can collect audience identification data by detecting the presence of a portable device (e.g., a wearable bracelet, a watch, a smartphone) that is associated with a panelist in the media presentation environment.

During fourth stage 108, the remote computing system processes and stores data received from the audience measurement meters and optionally the media monitor sites. For example, the remote computing system combines audience identification data and identification information from multiple panelist households to generate aggregated media monitoring information. In some instances, the remote computing system generates reports for advertisers, program producers, and/or other interested parties based on the compiled statistical data. Such reports can include extrapolations about the size and demographic composition of audiences of content, channels, and/or advertisements based on the demographics and behavior of the monitored panelists. The remote computing system can leverage demographic data collected from panelists during registration of the panelists with the AME.

In examples in which the remote computing system receives reference signatures, the remote computing system can compare signatures received from panelist households with the reference signatures. Various comparison criteria, such as a cross-correlation value or a Hamming distance, can be evaluated to determine whether a monitored signature matches a particular reference signature. When a match between the monitored signature and one of the reference signatures is found, the monitored media can be identified as corresponding to the particular reference media represented by the reference signature that matched the monitored signature. Because attributes, such as an identifier of the media, a presentation time, a broadcast channel, etc., are collected for the reference signature, these attributes may then be associated with the monitored media whose monitored signature matched the reference signature.

Data collected by an AME from a panelist household can be referred to as “panel data”. In some cases, to calculate more accurate audience measurement metrics, an AME supplements panel data with a data source having a much larger sample size relative to the panel data. This data source can include RPD.

RPD can include any data receivable at a media service provider, such as a cable or satellite television service provider e.g., multichannel video programming distributor (MVPD) or a streaming media service provider, via a return path to the media service provider from a media consumer site, network, or cloud (e.g., a remote digital video recorder (DVR) server). As such, RPD typically includes at least a portion of set-top box (STB) data collected by STBs. STB data may include, for example, tuning events and/or commands received by the STB (e.g., power on, power off, change channel, change input source, start presenting media, pause the presentation of media, record a presentation of media, volume up/down, etc.). Additionally or alternatively, STB data can include commands sent to a content provider by the STB (e.g., switch input sources, record a media presentation, delete a recorded media presentation, the time/date a media presentation was started, the time a media presentation was completed, etc.), heartbeat signals, or the like. Further, STB data can include a household identification (e.g. a household ID) and/or a STB identification (e.g. a STB ID). RPD can also include data from any other consumer device with network access capabilities (e.g., via a cellular network, the internet, other public or private networks, etc.). For example, RPD can include any or all of linear real-time data from an STB, guide user data from a guide server, click stream data, key stream data (e.g., any click on the remote—volume, mute, etc.), interactive activity (such as Video On Demand), and any other data (e.g., data from middleware).

RPD can additionally or alternatively include automatic content recognition (ACR) data. ACR data includes viewership data that is collected by a media device using ACR techniques (e.g., watermarking, fingerprinting, etc.). An example of such a device is a smart television (also referred to as a “Smart TV”) that is configured to connect to a network, such as the Internet, and execute applications. To collect ACR data, a Smart TV can use audio (and/or video) watermarking and/or fingerprinting techniques to process media received at the Smart TV and identify that media using a reference library to which the Smart TV has access. In some cases, the ACR data can identify what media was presented by the Smart TV and when. For instance, ACR data can indicate the channel that a Smart TV was tuned to and/or the name of a television program or advertisement.

An AME can enter into an agreement with various data providers to access and use RPD. For example, connected TV manufacturers and MVPDs can provide the AME with RPD.

### b. Example Computing System

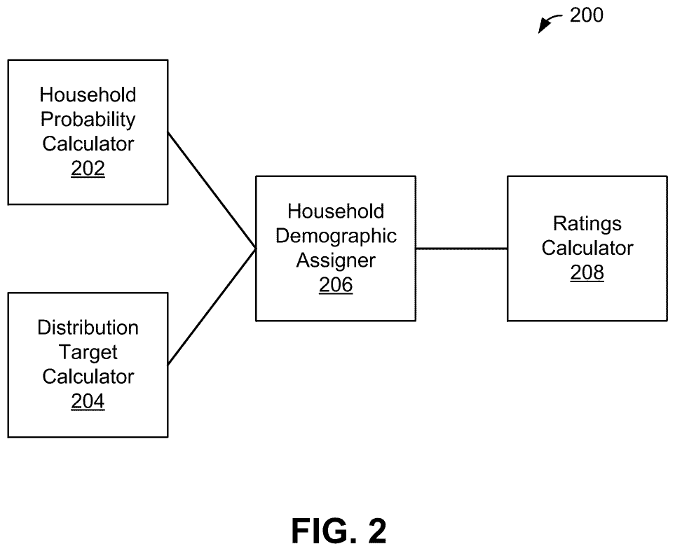

FIG. 2 is a simplified block diagram of an example audience measurement computing system 200 in which various described operations can be implemented. As shown in FIG. 2, audience measurement computing system 200 includes a household probability calculator 202, a distribution target calculator 204, a household demographic assigner 206, and a ratings calculator 208.

Household probability calculator 202 is configured to obtain RPD from households and predict estimated probabilities of different household demographic characteristics being associated with respective households. By way of example, household probability calculator 202 can extract features from the RPD and provide the features to a trained neural network. The trained neural network can then output probabilities for the demographic characteristics. The neural network can be trained using panelist tuning data collected from audience measurement meters monitoring media exposure in panel homes. An example neural network is described in U.S. patent application Pub. No. 2020/0226465 filed Dec. 6, 2019 and titled “Neural network processing of return path data to estimate household member and visitor demographics,” which is hereby incorporated by reference.

Distribution target calculator 204 is configured to determine distributions of one or more demographic characteristics for combinations of digital media providers in a television viewing area. By way of example, distribution target calculator 204 is configured to: determine, for each of multiple digital media providers, respective estimated distributions of a characteristic for a television viewing area; determine, for each of the multiple providers, respective reach values based on universe estimate for the television viewing area; determine, based on the respective reach values, a distribution of subscribers across overlapping combinations of the digital media providers; determine, for each of the multiple digital media providers based on the distribution of subscribers, respective mixed provider fractions relative to a total provider fraction for the digital media provider; and determine, using a constrained optimization (CO) routine that is constrained by the mixed provider fractions and the estimated distributions of the characteristic, target distributions of the characteristic for combinations of the digital media providers.

Household demographic assigner 206 is configured to use the estimated demographic classification probabilities output by the household probability calculator 202 and the target distributions output by the distribution target calculator 204 to assign values of a demographic characteristic(s) to one or more of the RPD households. For instance, the household demographic assigner 206 can assign demographic characteristics to households using mixed integer programming. As one example, the household demographic assigner 206 can solve an objective function to determine Boolean values of a matrix, with the Boolean values representing demographic characteristics assigned to respective RPD households. The household demographic assigner 206 can solve the objective function using a cost matrix that represents the cost of assigning different demographic characteristics to the RPD households subject to a number of constraints, such as the provider-specific distributions. An example household demographic assigner is described in the above-referenced U.S. patent application Pub. No. 2020/0226465.

Ratings calculator 208 is configured to determine ratings data and/or other audience metrics by using the household demographic assignments determined by the household demographic assigner 206. In some instances, rating calculator 208 combines the tuning information and corresponding demographic assignments with panelist data, which already has associated demographic data, to generate the ratings data and/or other audience metrics. One example of an audience metric is a number of households that are located in a television viewing area, have at least one demographic characteristic (e.g., have a Hispanic member), and consumed a particular television program. The ratings calculator 208 can provide ratings data and/or other audience metrics to another computing system. In some instances, the receiving computing system then uses the ratings data and/or other audience metrics to display an audience metric on a dashboard.

### Example Operations

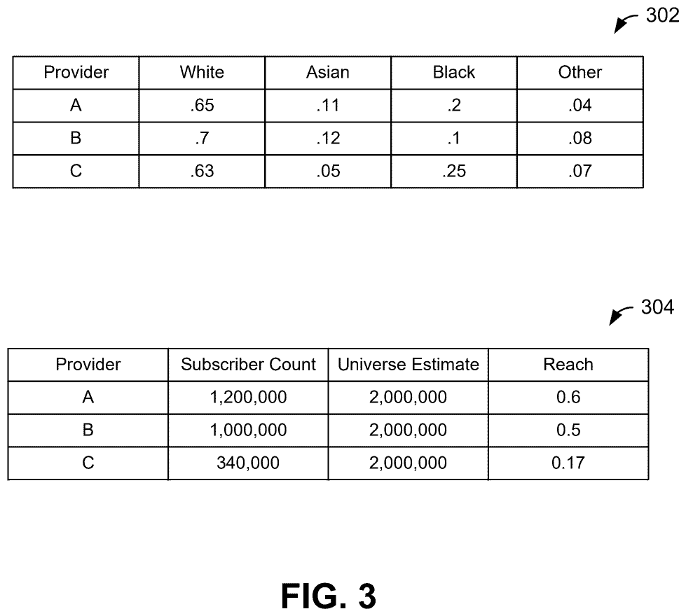

The audience measurement computing system 200 and/or components thereof can be configured to perform and/or can perform one or more operations. Examples of these operations and related features will now be described with reference to FIGS. 3-6.

a. Determining Reach Values

As described with reference to FIG. 3, three RPD providers may operate in a television viewing area: RPD provider A, RPD provider B, and RPD provider C. As a particular example, RPD provider A may be Comcast, RPD provider B may be Roku, and RPD provider C may be Amazon. Although this example includes just three RPD providers, the example is not meant to be limiting. The accompanying methodology can support any number of providers at the expense of complexity.

Demographic characteristic data 302 indicates that the demographic composition of the households that subscribe to the three RPD providers varies. For instance, for RPD provider A, 65% of the households are white, 11% of the households are Asian, 20% of the households are black, and 4% of the households are identify as another race. The distributions of the characteristic vary for RPD provider B and RPD provider C.

As further described with reference to FIG. 3, each RPD provider in a television viewing area has a number of subscribing households. Reach data 304 indicates that there are 2,000,000 households in the television view area. RPD provider A has 1,200,000 subscribing households, RPD provider B has 1,000,000 subscribing households, and RPD provider C has 340,000 subscribing households. For this television viewing area, the reach of a given RPD provider can be calculated by dividing the subscribing households for the given RPD provider by the universe estimate for the television viewing area. Note that the three reach values sum to greater than one, indicating that some households within the television viewing area subscribe to more than one of the three RPD providers.

In some instances, the audience measurement computing system 200 obtains the subscriber counts from the RPD providers, and stores the subscriber counts in a database. Alternatively, the audience measurement computing system 200 can determine the subscriber counts using panelist metadata. For instance, the AME may operate a panel in the television viewing area. For each panelist household in the television viewing area, the AME has corresponding metadata indicating the respective RPD provider(s) to which each household subscribes. Such metadata can be obtained based on registration of the panelist households with the AME. For instance, the AME can request that panelist households provide various information when registering with the AME. Additionally or alternatively, the AME can gather information for panelist households from an identity graph or an identity partner.

The panelist households in the television viewing area have respective weights that are derived by the AME. The AME assigns weights to the panelist households to ensure that the data collected from the panel accurately represents the target population. For instance, the weighting process can give more weight, and therefore influence in ratings and audience metrics, to households having demographic compositions that are underrepresented in the panel. The audience measurement computing system 200 can analyze the metadata and weights to estimate the subscriber counts for the respective RPD providers. As an example, the audience measurement computing system 200 can sum the weights of panelist households that are known subscribers of RPD provider A to determine a subscriber count for RPD provider A.

The audience measurement computing system 200 can obtain the universe estimate for the television viewing area from census data provided by a third-party, and store the universe estimate in the database or another database. The audience measurement computing system 200 can then determine the reach values using the subscriber counts and the universe estimate.

b. Determining Provider Overlaps

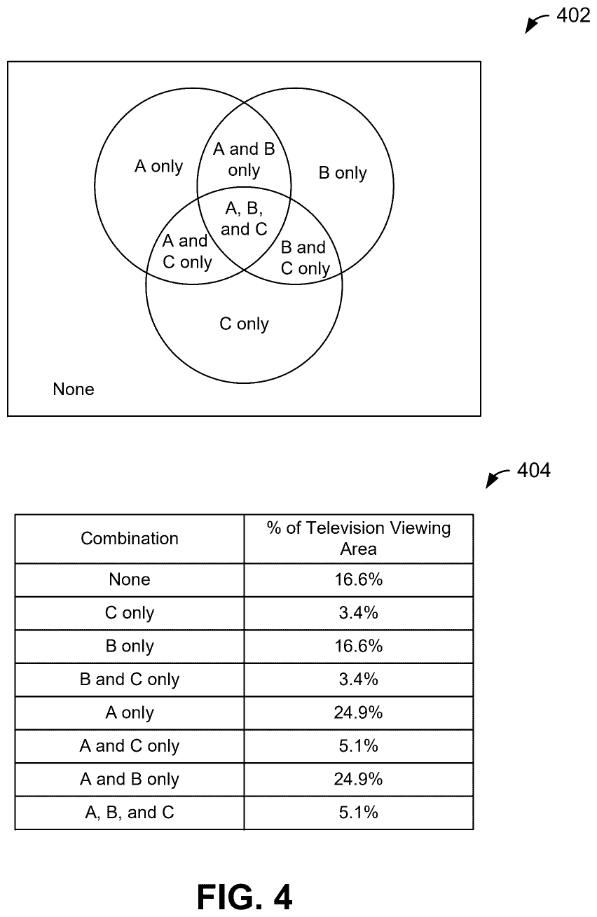

As described with reference to FIG. 4, the audience measurement computing system 200 can use the reach values of FIG. 3 with the assumption of independence and the inclusion-exclusion principle to determine the fraction of the television viewing area attributed to each of multiple possible overlap combinations of RPD provider A, RPD provider B, and RPD provider C. Conceptually, determining the provider overlaps is equivalent to solving for the percentage of households that fit within respective regions of a Venn diagram 402.

Distribution data 404 indicates that the percentage of households in the television viewing area that are not subscribers to any of RPD provider A, RPD provider B, and RPD provider C is 16.6%. The not-subscribers percentage is calculated by multiplying three factors together: (1—the reach of RPD provider A); (1—the reach of RPD provider B); and (1—the reach of RPD provider C).

Distribution data 404 further indicates that the percentage of households in the television viewing area that are only subscribers of RPD provider A is 24.9%. This percentage is calculated by multiplying three factors together: the reach of RPD provider A; (1—the reach of RPD provider B); and (1—the reach of RPD provider C).

Distribution data 404 further indicates that the percentage of households in the television viewing area that are only subscribers of RPD provider B is 16.6%. This percentage is calculated by multiplying three factors together: (1—the reach of RPD provider A); the reach of RPD provider B; and (1—the reach of RPD provider C).

Distribution data 404 further indicates that the percentage of households in the television viewing area that are only subscribers of RPD provider C is 3.4%. This percentage is calculated by multiplying three factors together: (1—the reach of RPD provider A); (1—the reach of RPD provider B), and the reach of RPD provider C.

The remaining percentages of the distribution data 404 are similarly calculated by multiplying three factors together, where the factor is either the reach of the RPD provider or the complement of the reach of the RPD provider, depending on whether the combination includes or excludes the RPD provider. For instance, the percentage of households in the television viewing area that are subscribers of RPD provider A and RPD provider B, but not RPD provider C is the product of: the reach of RPP provider A; the reach of RPD provider B; and (1—the reach of RPD provider C).

c. Determining Mixed Provider Fractions

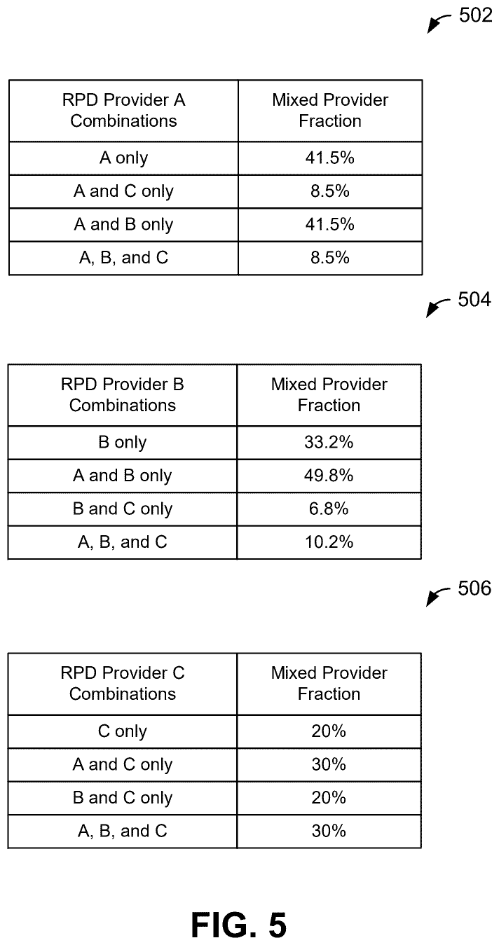

As described with reference to FIG. 5, the audience measurement computing system 200 can use the distribution data of FIG. 4 to determine mixed provider fractions. Conceptually, determining the mixed provider fractions is equivalent to rescaling the percentages of the distribution data to ensure that the percentages for all of the combinations that include at least a given RPD provider (e.g., at least RPD provider A) sum to 100%.

By way of example, when considering RPD provider A, distribution data 404 indicates that 24.9% of households are subscribers to only RPD provider A, 5.1% of households are subscribers to RPD provider A and RPD provider C only, 24.9% of households are subscribers to RPD provider A and RPD provider B only; and 5.1% of households are subscribers RPD provider A, RPD provider B, and RPD provider C. The sum of these four percentages is 60%. The audience measurement computing system 200 can determine the respective mixed provider fractions for these four combinations that include at least RPD provider A by dividing the respective percentages by 60%. For instance, first mixed provider fraction data 502 indicates that the mixed provider fraction for RPD provider A only is 24.9%/60%=41.5%, the mixed provider fraction for RPD provider A and RPD provider C only is 5.1%/60%=8.5%, and so forth.

The audience measurement computing system 200 can rescale the percentages in the distribution data for households that are subscribers of at least RPD provider B and the households that are subscribers of at least RPD provider C in a similar manner. Second mixed provider fractions 504 and third mixed provider fractions 506 indicate the mixed provider fractions for the combinations of RPD provider B subscribers and RPD provider C subscribers, respectively.

After determining the mixed provider fractions 502, the audience measurement computing system 200 stores the mixed provider fractions in a database for subsequent retrieval by the audience measurement computing system.

d. Determining Target Distributions

In line with the discussion above, the audience measurement computing system 200 can leverage a constrained optimization routine to determine target distributions of the household demographic characteristic for the combinations of the RPD providers in the television viewing area. The target distributions indicate, for each combination of providers, the percentages of households that have respective demographic characteristics.

Continuing with the example described with reference to FIGS. 3, 4, and 5, the audience measurement computing system 200 uses the mixed provider fractions and the estimated distributions of the characteristic to determine the target distributions. By way of example, the audience measurement computing system 200 can determine, as the target distributions, a solution to a convex optimization that is defined via CVXPY—an open-source Python-embedded modeling language for convex optimization problem.

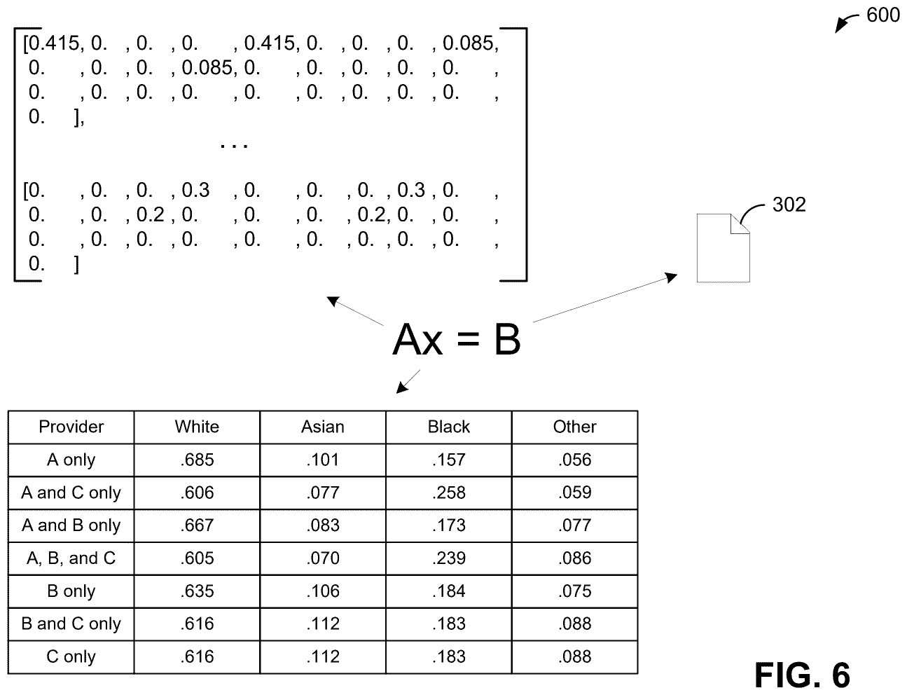

FIG. 6 illustrates a conceptual illustration 600 of an optimization problem and solution. In an example implementation, a matrix equation Ax=b is defined, where A is an input matrix, b is an input vector, and x is a solution vector.

The input matrix A is 12 rows and 28 columns that are strategically indexed with zeros and the mixed provider fractions to account for suitable linear algebra problems. More specifically, the four mixed provider fractions for RPD provider A are located, respectively, at columns 0, 4, 8, and 12 of row 0; columns 1, 5, 9, and 13 of row 1, columns 2, 6, 10, and 14 of row 2, and columns 3, 7, 11, and 15 of row 3. The four mixed provider fractions for RPD provider B are located, respectively, at columns 0, 4, 8, and 12 of row 4; columns 1, 5, 9, and 13 of row 5, columns 2, 6, 10, and 14 of row 6, and columns 3, 7, 11, and 15 of row 7. And the four mixed provider fractions for RPD provider C are located, respectively, at columns 0, 4, 8, and 12 of row 8; columns 1, 5, 9, and 13 of row 9, columns 2, 6, 10, and 14 of row 10, and columns 3, 7, 11, and 15 of row 11. For reference, rows 0 and 11 are shown in FIG. 6.

The input vector b is 12 rows and one column and is populated with the demographic characteristic data 302. More specifically, the values of b are 0.65; 0.11; 0.2; 0.04; 0.7; 0.12; 0.1; 0.08; 0.63; 0.05; 0.25; and 0.07.

The solution vector x has 28 values. The first four values indicate the percentage of households that are white, Asian, black, and other, respectively for households that only subscribe to RPD provider A, the next four values indicate the percentages of the demographic characteristic, respectively, for households that subscribe to RPD provider A and RPD provider C only. The third set of four values has percentages for households that subscribe to RPD provider A and RPD provider B only. The fourth set of four values has percentages for households that subscribe to RPD provider A, RPD provider B, and RPD provider C. The fifth set of four values has percentages for households that subscribe to RPD provider B only. The sixth set of four values has percentages for households that subscribe to RPD provider C only. And the last four values has percentages for households that do not subscribe to any of the RPD providers. In FIG. 6, the solution vector x is reshaped as a seven row by four column table for ease of visualization.

The constrained optimization routine can solve for values of the solution vector X that maximize the entropy of the solution subject to various constraints. For this example, the constraints included a first constraint that forces the weighted sums of the vectors for each RPD provider to be within a threshold amount of the known distribution of the demographic constraint for the RPD provider. For instance, the demographic characteristic data 302 indicates that 65% of the households that subscribe to RPD provider A are white. Hence, the constraint is designed to ensure that the weighted sum of the four combinations of RPD provider A households and their respective percentages of white households is within a threshold of 65%. In one example, the threshold amount is 20%. With this threshold amount, the first constraint can be expressed as follows: A*x>=0.8*b; and A*x<=1.2*b.

A second constraint forces the percentages within each combination to sum to one hundred percent. For example, this constraint forces the sum of the first four values of the solution vector x, which correspond to the percentages of households that subscribe to RPD provider A only that are white, Asian, black, or other, respectively, to sum to one hundred percent. Similarly, the first constraint forces the sets of four values of the solution vector x, which correspond to the six other combinations, to also some to one hundred percent.

A third constraint forces all values of the solution vector x to be within a threshold amount of a corresponding target percentage for the demographic characteristic within the television viewing area. For instance, for the television viewing area, the target percentage of white households may be W %, the target percentage of Asian households may be X %, the target percentage of black households may be Y %, and the target percentage of other households may be Z %. Further, the threshold amount may be 10%. This constraint can be expressed as x>=0.9*q; and x<=1.1*q, where q is a 28-element vector including the W, X, Y, and Z percentages repeated sequentially seven times. The third constraint prevents the solution from deviating too far from the target percentages for the distribution of the demographic characteristic.

In one example, the target percentages are determined using deduplicated reach fractions that are based on weighted sums of the demographic characteristic data 302. The weights for the weighted sum can be determined using the distribution data 404. For instance, the fraction of households having only one of the three RPD providers is 16.6%+24.9%+3.4%=44.9%. The weight for RPD provider A is then this sum divided by the fraction of households only subscribing to RPD provider A: 0.449/0.249=0.55. Similarly the weight for RPD provider B is 0.449/0.166=0.37. And the weight for RPD provider C is 0.449/0.034=0.08. The target percentage for white households is then determined using these weights and the demographic characteristic data 302: 0.55*0.65+0.37*0.7+0.08*0.63=67%. Similarly, the target percentages for Asian, black, and other households are 0.11%, 17%, and 6%.

For reference, example values of the solution vector x are shown in the seven row by four column table in the conceptual illustration 600. Note that the weighted sums of the vectors for each RPD provider are within a threshold amount of the known distribution of the demographic constraint for the RPD provider. For instance, the weighted sum of the white households that are subscribers to RPD provider A only (68.5%), RPD providers A and C only (60.6%), RPD providers A and B only (66.7%), and RPD providers A, B, and C (60.5%), when weighted by the mixed provider fractions for RPD provider A, is 0.685*0.415+0.606*0.085+0.667*0.415+0.605*0.085=66.4%. This percentage is within ten percent of the 65% of white households for RPD provider A specified by the demographic characteristic data 302.

In addition, the values of the solution vector x indicated within each row of the table sum to approximately one. And moreover, the values of the solution vector x are within 10% of the target percentages for white (67%), Asian (11%), black (17%), and other (6%) households.

Recall that the values of the solution vector X are target distributions of the demographic characteristic for the combinations of the RPD providers in the television viewing area. Because the values of the solution vector X were derived using the reach values and mixed provider fractions, the target distributions of the characteristic for the combinations account for overlaps between RPD providers in the television viewing area. In some examples, the audience measurement computing system 200 can provide the target distributions to a household demographic assigner, such as the household demographic assigner 206, for use as constraints for household demographic assignment. From the foregoing, one of ordinary skill in the art will appreciate that using target distributions for household demographic assignment provides more accurate demographic assignments, and in turn, more accurate ratings and audience metrics as opposed to a process that generates ratings without accounting for the overlap amongst the RPD providers to which the households in the television viewing area are subscribed. Hence, the operations described herein reflect an improvement to RPD-based audience measurement, an inherently technical endeavor.

### a. Example Method

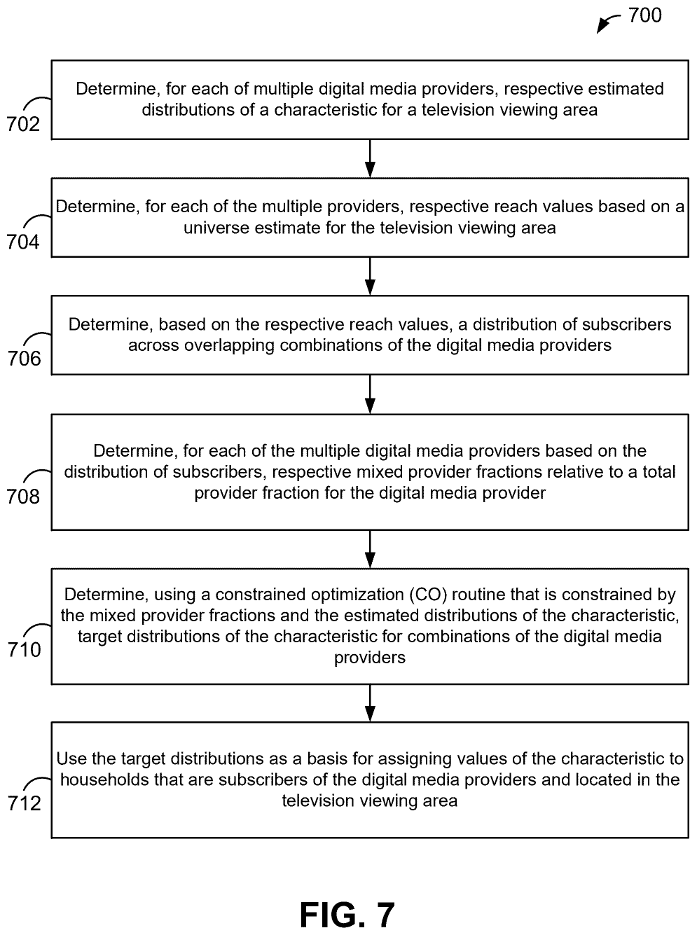

FIG. 7 is a flow chart of an example method 700. Method 700 can be carried out by a computing system, such as the distribution target calculator 204. At block 702, method 700 includes determining, for each of multiple digital media providers, respective estimated distributions of a characteristic for a television viewing area. At block 704, method 700 includes determining, for each of the multiple providers, respective reach values based on a universe estimate for the television viewing area. At block 706, method 700 includes determining, based on the respective reach values, a distribution of subscribers across overlapping combinations of the digital media providers. At block 708, method 700 includes determining, for each of the multiple digital media providers based on the distribution of subscribers, respective mixed provider fractions relative to a total provider fraction for the digital media provider. At block 710, method 700 includes determining, using a constrained optimization routine that is constrained by the mixed provider fractions and the estimated distributions of the characteristic, target distributions of the characteristic for combinations of the digital media providers. And at block 712, method 700 includes using the target distributions as a basis for assigning values of the characteristic to households that are subscribers of the digital media providers and located in television viewing area.

### IV. Example Computing Device

Any one or more of the above-described components, such as household probability calculator 202, distribution target calculator 204, household demographic assigner 206, and/or ratings calculator 208 can take the form of a computing device, or a computing system that includes one or more computing devices.

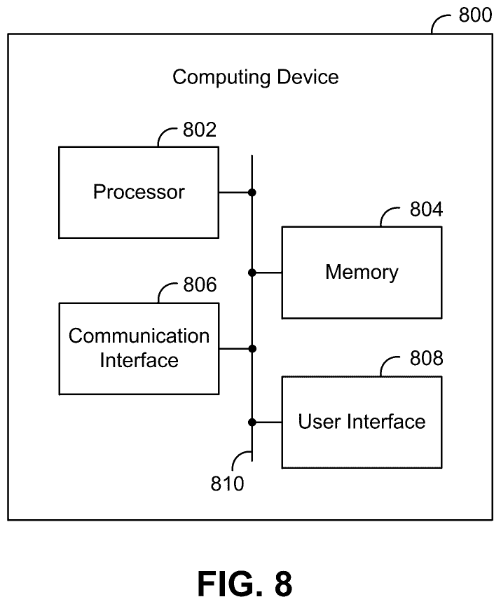

FIG. 8 is a simplified block diagram of an example computing device 800. The computing device 800 can be configured to perform one or more operations, such as the operations described in this disclosure. As shown, the computing device 800 can include various components, such as a processor 802, memory 804, a communication interface 806, and/or a user interface 808. These components can be connected to each other (or to another device, system, or other entity) via a connection mechanism 810.

The processor 802 can include one or more general-purpose processors and/or one or more special-purpose processors.

Memory 804 can include one or more volatile, non-volatile, removable, and/or non-removable storage components, such as magnetic, optical, or flash storage, and/or can be integrated in whole or in part with the processor 802. Further, memory 804 can take the form of a non-transitory computer-readable storage medium, having stored thereon computer-readable program instructions (e.g., compiled or non-compiled program logic and/or machine code) that, upon execution by the processor 802, cause the computing device 800 to perform one or more operations, such as those described in this disclosure. The program instructions can define and/or be part of a discrete software application. In some examples, the computing device 800 can execute the program instructions in response to receiving an input (e.g., via the communication interface 806 and/or the user interface 808). Memory 804 can also store other types of data, such as those types described in this disclosure. In some examples, memory 804 can be implemented using a single physical device, while in other examples, memory 804 can be implemented using two or more physical devices.

The communication interface 806 can include one or more wired interfaces (e.g., an Ethernet interface) or one or more wireless interfaces (e.g., a cellular interface, Wi-Fi interface, or Bluetooth® interface). Such interfaces allow the computing device 800 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission.

The user interface 808 can facilitate interaction between computing device 800 and a user of computing device 800, if applicable. As such, the user interface 808 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 808 can include hardware and/or software components that facilitate interaction between the computing device 800 and the user of the computing device 800.

The connection mechanism 810 can be a cable, system bus, computer network connection, or other form of a wired or wireless connection between components of the computing device 800.

One or more of the components of the computing device 800 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 800 can be combined into a single component, and the function described herein for a single component can be subdivided among multiple components.

### V. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A computing system comprising a processor and a memory, the computing system configured to perform a set of acts comprising:
determining, for each of multiple digital media providers, respective estimated distributions of a characteristic for a television viewing area;
determining, for each of the multiple digital media providers, respective reach values based on a universe estimate for the television viewing area;
determining, based on the respective reach values, a distribution of subscribers across overlapping combinations of the digital media providers;
determining, for each of the multiple digital media providers based on the distribution of subscribers, respective mixed provider fractions relative to a total provider fraction for the digital media provider;
determining, using a constrained optimization (CO) routine that is constrained by the mixed provider fractions and the estimated distributions of the characteristic, target distributions of the characteristic for combinations of the digital media providers; and
using the target distributions of the characteristic as a basis for assigning values of the characteristic to households that are subscribers of the digital media providers and located in the television viewing area.

2. The computing system of claim 1, wherein the CO routine is further constrained by averages of the estimated distributions of the characteristic across the digital media providers.

3. The computing system of claim 1, wherein the CO routine is a maximum entropy solver.

4. The computing system of claim 1, wherein determining the distribution of the subscribers across overlapping combinations of the digital media providers comprises determining fractions of the subscribers for respective ones of the overlapping combinations.

5. The computing system of claim 1, wherein the set of acts further comprises generating a measurement metric using: a value of the characteristic that is assigned to a household that is a subscriber of at least two of the digital media providers and located in the television viewing area, and tuning data for the household.

6. The computing system of claim 5, wherein the set of acts further comprises causing display of the measurement metric on a dashboard.

7. The computing system of claim 1, wherein the set of acts further comprises sending data indicative of the values of the characteristic assigned to the households to another computing system.

8. A method comprising:
determining, by a computing system for each of multiple digital media providers, respective estimated distributions of a characteristic for a television viewing area;
determining, by the computing system for each of the multiple digital media providers, respective reach values based on a universe estimate for the television viewing area;
determining, by the computing system based on the respective reach values, a distribution of subscribers across overlapping combinations of the digital media providers;
determining, by the computing system for each of the multiple digital media providers based on the distribution of subscribers, respective mixed provider fractions relative to a total provider fraction for the digital media provider;
determining, by the computing system using a constrained optimization (CO) routine that is constrained by the mixed provider fractions and the estimated distributions of the characteristic, target distributions of the characteristic for combinations of the digital media providers; and
using the target distributions of the characteristic as a basis for assigning values of the characteristic to households that are subscribers of the digital media providers and located in the television viewing area.

9. The method of claim 8, wherein the CO routine is further constrained by averages of the estimated distributions of the characteristic across the digital media providers.

10. The method of claim 8, wherein the CO routine is a maximum entropy solver.

11. The method of claim 8, wherein determining the distribution of the subscribers across overlapping combinations of the digital media providers comprises determining fractions of the subscribers for respective ones of the overlapping combinations.

12. The method of claim 8, further comprising generating a measurement metric using: a value of the characteristic that is assigned to a household that is a subscriber of at least two of the digital media providers and located in the television viewing area, and tuning data for the household.

13. The method of claim 12, further comprising causing display of the measurement metric on a dashboard.

14. The method of claim 8, further comprising sending data indicative of the values of the characteristic assigned to the households to another computing system.

15. A non-transitory computer-readable storage medium having stored thereon instructions, that upon execution by a computing system, cause the computing system to perform a set of acts comprising:
determining, for each of multiple digital media providers, respective estimated distributions of a characteristic for a television viewing area;
determining, for each of the multiple digital media providers, respective reach values based on a universe estimate for the television viewing area;
determining, based on the respective reach values, a distribution of subscribers across overlapping combinations of the digital media providers;
determining, for each of the multiple digital media providers based on the distribution of subscribers, respective mixed provider fractions relative to a total provider fraction for the digital media provider;
determining, using a constrained optimization (CO) routine that is constrained by the mixed provider fractions and the estimated distributions of the characteristic, target distributions of the characteristic for combinations of the digital media providers; and
using the target distributions of the characteristic as a basis for assigning values of the characteristic to households that are subscribers of the digital media providers and located in the television viewing area.

16. The non-transitory computer-readable storage medium of claim 15, wherein the CO routine is further constrained by averages of the estimated distributions of the characteristic across the digital media providers.

17. The non-transitory computer-readable storage medium of claim 15, wherein the CO routine is a maximum entropy solver.

18. The non-transitory computer-readable storage medium of claim 15, wherein determining the distribution of the subscribers across overlapping combinations of the digital media providers comprises determining fractions of the subscribers for respective ones of the overlapping combinations.

19. The non-transitory computer-readable storage medium of claim 15, wherein the set of acts further comprises generating a measurement metric using: a value of the characteristic that is assigned to a household that is a subscriber of at least two of the digital media providers and located in the television viewing area, and tuning data for the household.

20. The non-transitory computer-readable storage medium of claim 19, wherein the set of acts further comprises causing display of the measurement metric on a dashboard.
